(19) United States
(12) Patent Application Publication
(10) Pub. No.: US 2013/0229630 A1
(43) Pub. Date: Sep. 5, 2013

(54) PROJECTOR AND CONTROL METHOD

(71) Applicants: So Nishimura, Tokyo (JP); Osamu Ishibashi, Tokyo (JP); Yoshiho Yanagita, Tokyo (JP)

(72) Inventors: So Nishimura, Tokyo (JP); Osamu Ishibashi, Tokyo (JP); Yoshiho Yanagita, Tokyo (JP)

(21) Appl. No.: 13/884,199

(22) PCT Filed: Oct. 20, 2011
(86) PCT No.: PCT/JP2011/074160

§ 371 Date: May 8, 2013

(30) Foreign Application Priority Data
Dec. 13, 2010 (JP) 2010-276835

(51) Int. Cl. G03B 21/20

(52) U.S. Cl. CPC G03B 21/206
USPC 353/31; 353/121

(57) ABSTRACT

A projector includes a screen which has color stripes that are periodically arranged and that generate visible light corresponding to incident light. A laser light source section emits a light beam. A laser scanning section scans the light beam on a region of the color stripes arranged on the screen. A light detection section detects feedback light radiated from the screen corresponding to the light beam. A control section adjusts a light emission timing and a light emission period of the laser light source section based on a detection result of the light detection section and causes the laser light source section to emit the light beam such that light pulses enter the individual color stripes.

### TECHNICAL FIELD

The present invention relates to a projector that scans a light beam on a screen so as to display an image.

### BACKGROUND ART

In recent years, scanning projectors that scan a light beam on a phosphor screen have become attractive. Such scanning projectors often use a resonant scanning element such as a Galvanometer mirror as a scanning means that scans a light beam on a phosphor screen. Although resonant scanning elements can scan a light beam on a screen at a high speed, their scanning speed and scanning amplitude tend to change depending on the ambient temperature and so forth. Thus, it is not easy to enter a light beam to an appropriate incident position on the screen.

A scanning-beam display system that can adjust the incident position of a light beam on a screen is described in Patent Literature 1.

On the phosphor screen used for the scanning-beam display system described in Patent Literature 1, a plurality of phosphor stripes are periodically arranged and servo reference marks that reflect a light beam are arranged between adjacent phosphor stripes.

In the scanning-beam display system, a light source emits a light beam composed of a plurality of light pulses. The light beam scans the foregoing phosphor screen in the direction orthogonal to the phosphor stripes. The light beam excites phosphors of the phosphor stripes so as to display an image.

In the scanning-beam display system, whenever a light beam is scanned onto a screen, the light emission timing of the light source changes. When the incident position of a light pulse changes, since the amount of light that enters a servo reference mark changes, the amplitude of feedback light reflected from the servo reference mark also changes. The scanning-beam display system detects changes of the amplitude of the feedback light and adjusts the light emission timing of the light source based on the detection result and thereby adjusts the incident positions of light pulses so as to enter them to the phosphor stripes.

### RELATED ART LITERATURE

Patent Literature

Patent Literature 1: JP2009-539120A, Publication (translation version)

### SUMMARY OF THE INVENTION

Problem to be Solved by the Invention

If the scanning speed of the resonant scanning element changes, even if light pulses having a predetermined pulse width are emitted from the light source, the emission region of the light pulses on the screen changes.

The scanning-beam display system described in Patent Literature 1 adjusts the light emission timing of the light source, not the light emission period of the light source. Thus, even if the scanning speed changes, the scanning-beam display system emits light pulses with the same pulse width. As a result, the emission region of the light pulses unnecessary becomes large. Consequently, a problem arises in which the emission region of light that are pulses on the screen protrudes from the phosphor stripes and thereby the use efficiency of light decreases.

An object of the present invention is to provide a projector and a control method that can solve the foregoing program in which the use efficiency of light decreases.

Means that Solve the Problem

A projector according to the present invention includes a screen having color stripes that are periodically arranged and that generate visible light corresponding to incident light; a light source that emits a light beam; a projection section that scans said light beam on a region of said color stripes arranged on said screen; a detection section that detects feedback light radiated from said screen corresponding to said light beam; and a control section that adjusts a light emission timing and a light emission period of said light source based on a detection result of said detection section and causes said light source to emit said light beam such that light pulses enter the individual color stripes.

A control method according to the present invention is a control method for a projector including a screen having color stripes that are periodically arranged and that generate visible light corresponding to incident light; a light source that emits a light beam; and a projection section that scans said light beam on a region of said color stripes arranged on said screen, including detecting feedback light radiated from said screen corresponding to said light beam; and adjusting a light emission timing and a light emission period of said light source based on the detection result and causing said light source to emit said light beam such that light pulses enter the individual color stripes.

### EFFECT OF THE INVENTION

According to the present invention, the use efficiency of light can be increased.

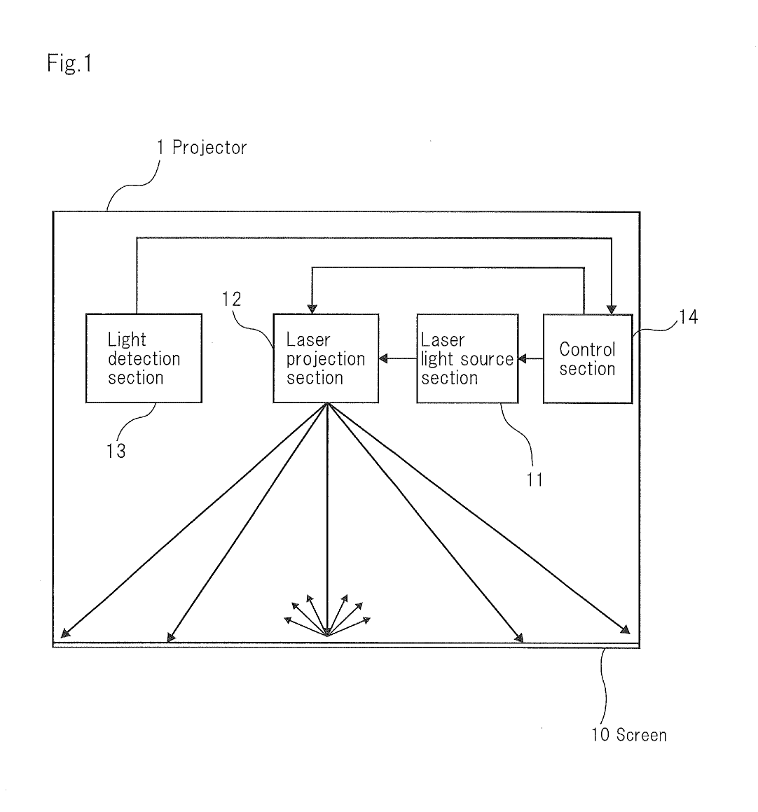

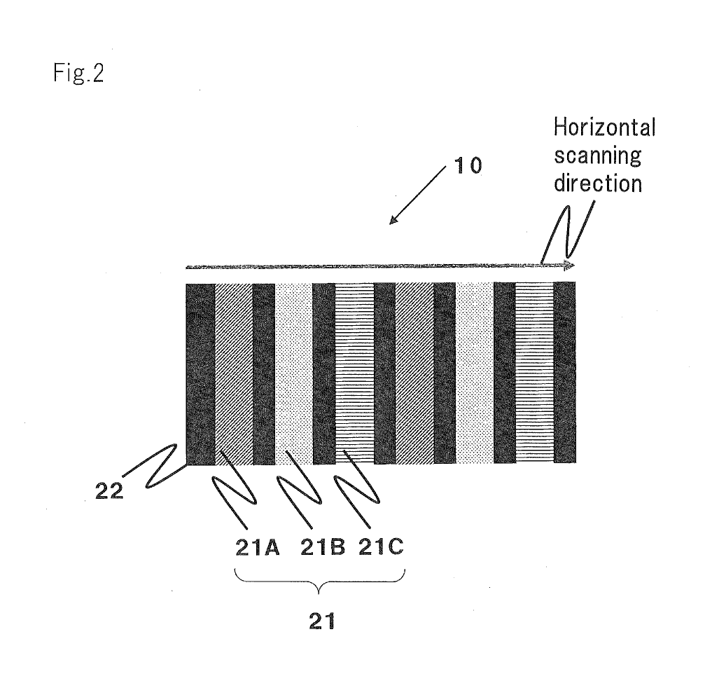

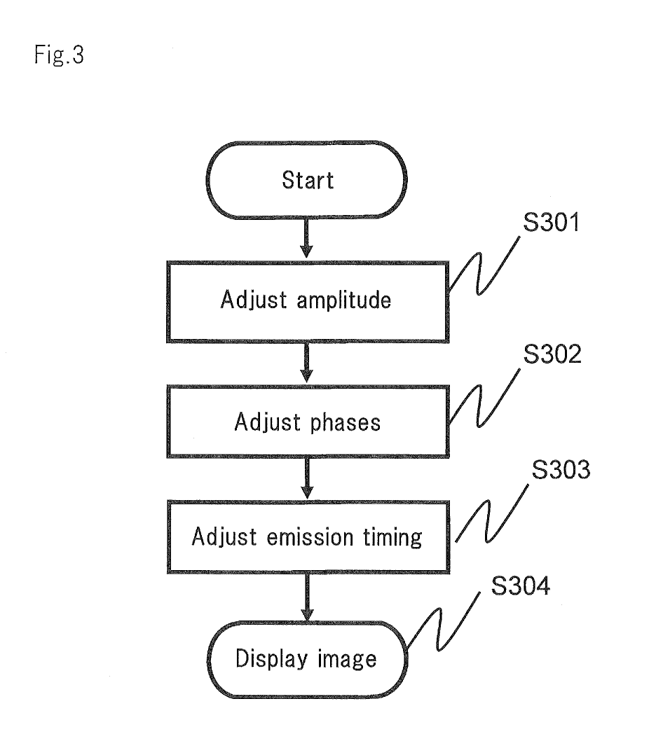

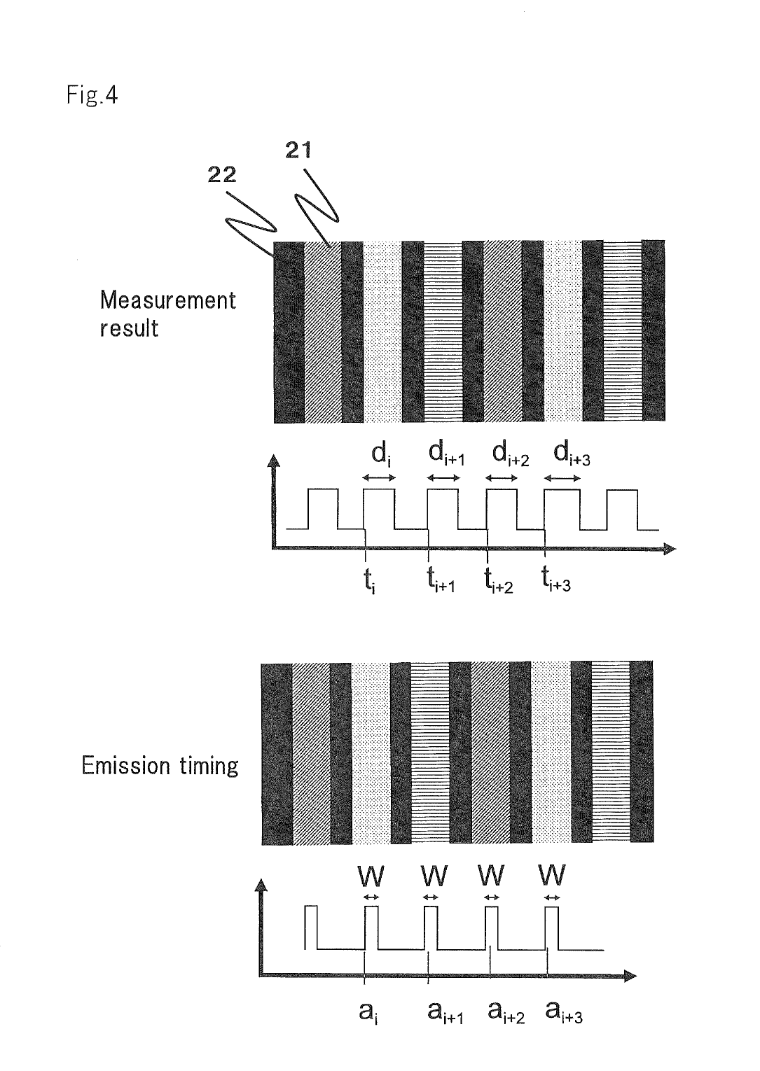

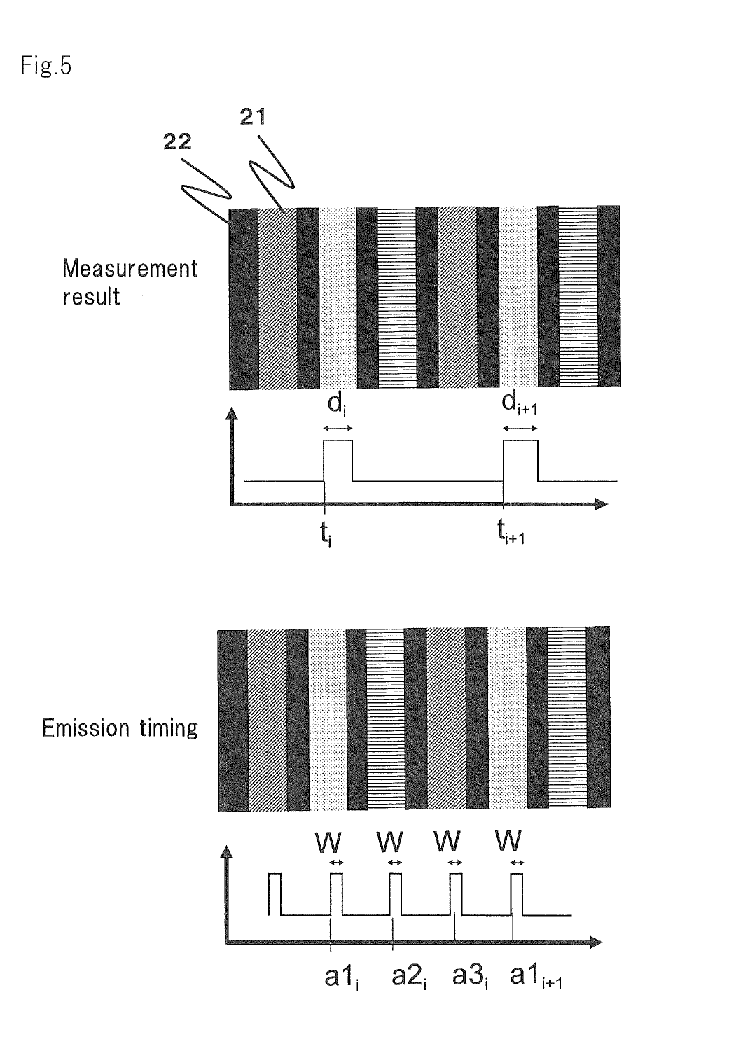

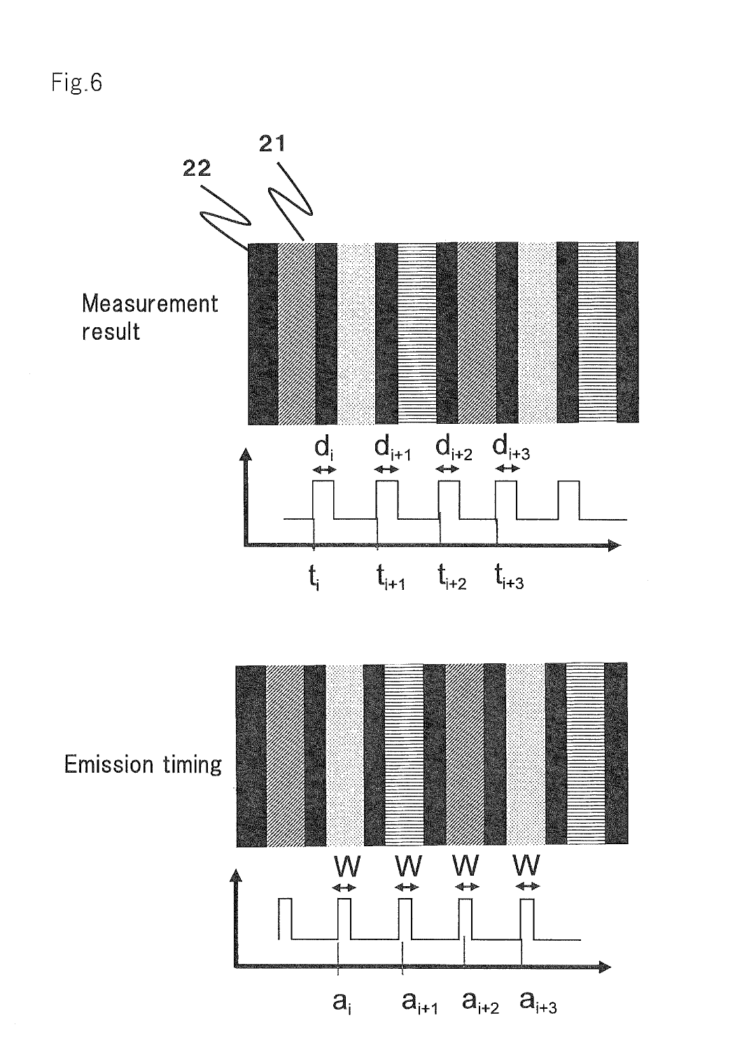

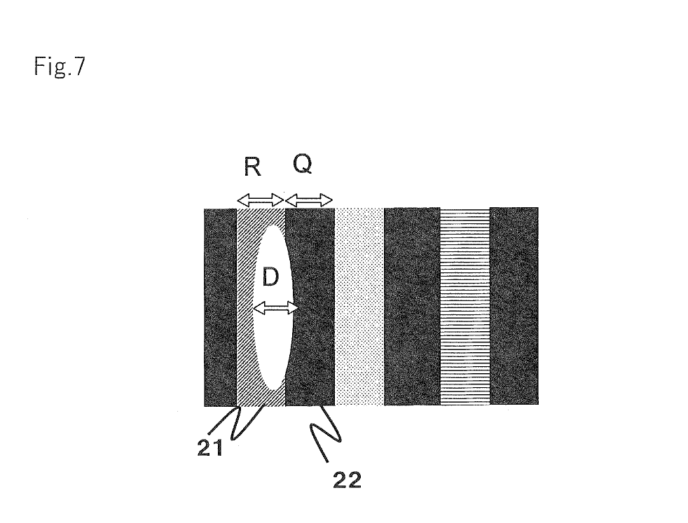

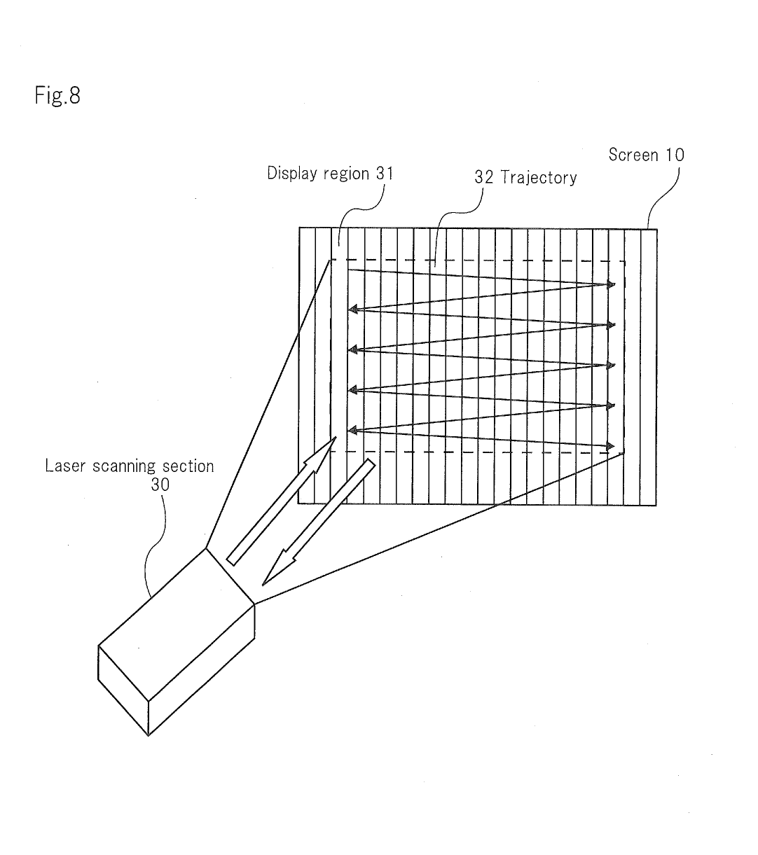

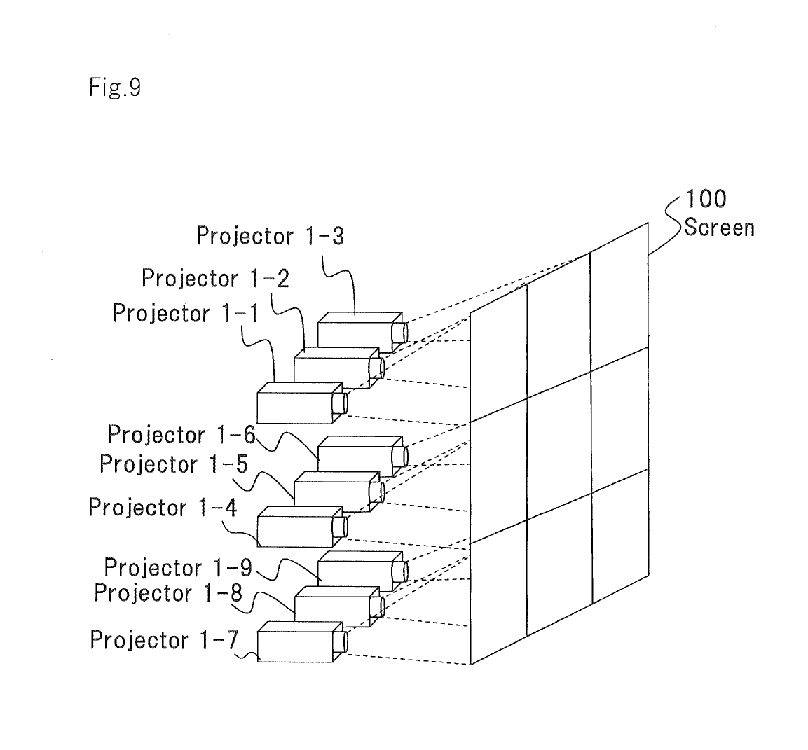

### BRIEF DESCRIPTION OF DRAWINGS

[FIG. 1 ] is a schematic diagram showing a projector according to a first embodiment of the present invention.

[FIG. 2] is a schematic diagram showing a specific example of the structure of a screen.

[FIG. 3] is a flow chart describing the operation of the projector.

[FIG. 4] is a schematic diagram describing an example of a calculation method that specifies the mutual relationship between the emission timing and pulse width of each of the display light pulses.

[FIG. 5] is a schematic diagram describing another example of a calculation method that specifies the mutual relationship between the emission timing and pulse width of each of the display light pulses.

[FIG. 6] is a schematic diagram describing another example of a calculation method that specifies the mutual relationship between the emission timing and pulse width of each of the display light pulses.

[FIG. 7] is a schematic diagram showing parameters that decide the emission timing and pulse width of each of display light pulses.

[FIG. 8] is a schematic diagram showing that the screen is scanned with laser light.

[FIG. 9] is a schematic diagram showing an example of a multiprojector system.

### BEST MODES THAT CARRY OUT THE INVENTION

Next, with reference to the accompanying drawings, embodiments of the present invention will be described. In the following description, similar portions having similar functions may be denoted by similar reference numerals and their description may be omitted.

FIG. 1 is a schematic diagram showing a projector according to a first embodiment of the present invention. Projector 1 shown in FIG. 1 is a scanning rear projector that scans laser light that is a light beam on the rear surface of a screen so as to display an image. Projector 1 is provided with screen 10, laser light source section 11, laser projection section 12, light detection section 13, and control section 14.

Screen 10 has color stripes that are periodically arranged in the in-plane direction and that generate visible light corresponding to incident light. Black stripes that block incident light are arranged between adjacent color stripes.

FIG. 2 is a schematic diagram showing a specific structure of part of screen 10. As shown in FIG. 2, color stripes 21 are periodically arranged on screen 10. Black stripes 22 are arranged between adjacent color stripes.

Phosphors are formed on color stripes 21. Color stripes 21 generate fluorescent light corresponding to incident light and radiate it to the front surface of the screen. It is assumed that the wavelength of fluorescent light ranges in the visible light region.

In FIG. 2, color stripes 21 are composed of color strips 21A, 21B, and 21C that are sub color stripes having different fluorescent wavelengths that are successively and repeatedly arranged in a predetermined direction. For example, color stripes 21A generate red fluorescent light; color stripes 21B generate green fluorescent light; and color stripes 21C generate blue fluorescent light. In addition, it is assumed that color stripes 21 are arranged in the horizontal direction such that the horizontal scanning direction of laser projection section 12 intersects with the longitudinal direction of color stripes 21.

If laser light radiated to screen 10 is visible light (wavelength: around 380 nm to 730 nm), color stripes 21 may be formed of light diffusion materials instead of phosphors. In this case, color stripes 21 diffuse laser light so as to generate visible light to be displayed and emit it to the front surface of screen 10.

Black stripes 22 absorb or reflect and block laser light such that they do not transmit the laser light through the front surface of screen 10. Reflection includes diffusion reflection, retroreflective reflection, and so forth.

At least either of color stripes 21 and black stripes 22 reflect laser light (or diffuses or retro-reflects laser light) or convert laser light into light having a different wavelength and guide at least part of the reflected light or diffused light as feedback light to light detection section 13. In this context, light having another wavelength is fluorescent light generated by color stripes 21.

Returning to the description of FIG. 1, laser light source section 11 is a light source composed of a semiconductor laser element or a solid state laser element that emits laser light.

Laser projection section 12 scans laser light emitted from laser light source section 11 on the region of the color stripes arranged on the rear surface of screen 10 so as to display an image on screen 10. In addition, since laser projection section 12 can scan laser light at least in the horizontal direction on screen 10, a one-dimensional SLM (Spatial Light Modulator) or the like may draw an image in the vertical direction. A scanning means that scans laser light on screen 10 is preferably a resonant light scanning element such as a Galvanometer mirror.

Light detection section 13 is a detection section that is composed of a photoelectric conversion device and that detects feedback light radiated from screen 10 corresponding to laser light projected on screen 10. The photoelectric conversion device is, for example, a PD (Photodiode) such as an APD (Avalanche Photodiode).

Control section 14 performs a calibration that adjusts the image display region of screen 10, the light emission timing of laser light source section 11, and so forth. For example, control section 14 adjusts the light emission timing and light emission period of laser light source section 11 based on the detection result of light detection section 13 such that light pulses enter color stripes 21 on screen 10.

After control section 14 has performed the calibration, while control section 14 causes laser light source section 11 to emit laser light based on the result of the calibration such that light pulses enter color stripes 21, control section 14 causes laser projection section 12 to scan laser light on screen 10 such that it displays an image corresponding to the input image signal.

Next, the operation of projector 1 will be described.

FIG. 3 is a flow chart describing the operation of projector 1.

When projector 1 is started, control section 14 executes the calibration. For example, projector 1 is provided with a power switch (not shown). When the switch is turned on, control section 14 determines that projector 1 has started and executes the calibration.

When projector 1 executes the calibration, control section 14 adjusts the scanning amplitude of laser projection section 12 so as to adjust the display region of an image (at step S301).

Thereafter, control section 14 performs phase matching that causes the horizontal scanning frequency of laser projection section 12 to synchronize with the horizontal synchronous signal of the input image signal (at step S302).

Thereafter, control section 14 causes laser light source section 11 to emit continuous light as laser light, laser projection section 12 to scan the continuous light in the horizontal scanning direction on screen 10, and adjusts the emission timings of light pulses that enter color stripes 21 and the radiation timing that generates control information that represents the pulse width based on the detection result of light detection section 13. Now, control section 14 completes the calibration (at step S303).

Thereafter, while control section 14 adjusts the light emission timing and the light emission period of laser light source section 11 based on the control information generated at step S303, control section 14 causes laser projection section 12 to scan laser light on screen 10 corresponding to the input image signal so as to display an image corresponding to the input image signal on screen 10 (at step S304). The luminance of the display image can be changed by adjusting the amplitude of light pulses.

Next, the radiation timing adjustment that controls section 14 performs will be described in detail.

When control section 14 adjusts the radiation timing, control section 14 causes laser light source section 11 and laser projection section 12 to scan continuous light on screen 10 in the horizontal scanning direction and specifies the mutual relationship between the emission timing and pulse width of each of the display light pulses that are light pulses that enter color stripes 21 corresponding to the detection result of light detection section 13.

FIG. 4 is a schematic diagram describing a first calculation method that specifies the mutual relationship between the emission timing and pulse width of each of display light pulses.

In the example shown in FIG. 4, light detection section 13 detects sub feedback light that is a plurality of light pulses radiated from color stripes 21 as feedback light that is radiated from screen 10.

Now, it is assumed that the detection timing (detection start time) in which light detection section 13 detects sub feedback light that is radiated from i-th color stripe 21 in the horizontal scanning direction is denoted by tᵢ and that the detection width is denoted by dᵢ. In addition, it is assumed that the pulse width of each of the display light pulses that enter color stripes 21 is denoted by W and that the emission timing of display light pulses that enter i-th color stripe 21 is denoted by aᵢ. In this case, control section 14 specifies the mutual relationship between the emission timing and pulse width of each of display light pulses as expressed

$${a}_{i} = {t}_{i} + \frac{{d}_{i} - W}{2} \qquad [ Mathematical Expression 1 ]$$

by the foregoing formula.

FIG. 5 is a schematic diagram describing a second calculation method that specifies the mutual relationship between the emission timing and pulse width of each of display light pulses.

In the example shown in FIG. 5, light detection section 13 detects sub field light that is a plurality of light pulses radiated from a plurality of predetermined detection stripes of color stripes 21 as feedback light.

Now, it is assumed that the detection timing in which light detection section 13 detects sub feedback light that is radiated from i-th detection stripe in the horizontal scanning direction is denoted by tᵢ and that the detection width is denoted by dᵢ. In addition, it is assumed that the number of target color stripes arranged from i-th detection stripe to a color stripe that is immediately preceded by the next detection stripe is denoted by n, the pulse width of each of display color pulses that enter color stripes 21 is denoted by W, and the emission timing of a display light pulse that enters a target color stripe apart from i-th detection stripe by j stripes is denoted by ajᵢ.

In this case, control section 14 specifies the mutual relationship between the emission timing and pulse width of each of display light pulses as expressed

$${aj}_{i} = {t}_{i} + \frac{{d}_{i} - W}{2} + ( j - 1 ) \cdot \frac{{t}_{i + 1} - {t}_{i}}{n} \qquad [ Mathematical Expression 2 ]$$

by the foregoing formula.

In the foregoing second calculation method, if detection stripes are predetermined color stripes of color stripes 21A, 21B, and 21C, since n=3, the mutual relationship between the emission timing and pulse width of each of display light pulses can be expressed

$$\\ a {1}_{i} = {t}_{i} + \frac{{d}_{i} - W}{2} \\ \begin{matrix}a {2}_{i} = a {1}_{i} + \frac{{t}_{i + 1} - {t}_{i}}{3} \\ = {t}_{i} + \frac{{d}_{i} - W}{2} + \frac{{t}_{i + 1} - {t}_{i}}{3}\end{matrix} \\ \begin{matrix}a {3}_{i} = a {2}_{i} + \frac{{t}_{i + 1} - {t}_{i}}{3} \\ = {t}_{i} + \frac{{d}_{i} - W}{2} + 2 \frac{{t}_{i + 1} - {t}_{i}}{3}\end{matrix} \qquad [ Mathematical Expression 3 ]$$

by the foregoing formula.

FIG. 6 is a schematic diagram describing a third calculation method that specifies the mutual relationship between the emission timing and pulse width of each of the display light pulses.

In the example shown in FIG. 6, light detection section 13 detects sub feedback light that is a plurality of light pulses that are radiated from black stripes 22 as feedback light.

Now, it is assumed that the detection timing in which light detection section 13 detects sub feedback light from i-th black stripe in the horizontal direction is denoted by tᵢ and that the detection width is denoted by dᵢ. In addition, it is assumed that the pulse width of each of display light pulses that enter color stripes 21 is denoted by W and the emission timing of each of display light pulses that enter i-th color stripe is denoted by bᵢ. In this case, control section 14 specifies the mutual relationship between the emission timing and pulse width of each of display light pulses as expressed

$$\begin{matrix}{a}_{i} = \frac{{t}_{i + 1} - {t}_{i} - {d}_{i}}{2} - \frac{W}{2} + {t}_{i} + {d}_{i} \\ = \frac{{t}_{i + 1} + {t}_{i} + {d}_{i} - W}{2}\end{matrix} \qquad [ Mathematical Expression 4 ]$$

by the preceding formula.

If control section 14 specifies the mutual relationship between the emission timing and pulse width of each of the display light pulses according to the foregoing first to third calculation method, as shown in FIG. 4 to FIG. 6, the display light pulses can be caused to enter color stripes.

If the relationship of dᵢ>W is satisfied for all detection widths dᵢ, display light pulses can be caused to enter color stripes. Thus, if the pulse width W has been set for a sufficiently small value, control section 14 can prevent display light pulses from protruding from desired color strips and thereby from entering other color stripes and black stripes. As a result, the use efficiency of light can be increased.

However, if the pulse width is small, the luminance of an image may decrease. Thus, after control section 14 specifies the mutual relationship between the emission timing and pulse width of each of the display light pulses, control section 14 further specifies the pulse width of each of the display light pulses so as to optimize the pulse width of each of display light pulses.

For example, control section 14 causes laser light source section 11 and laser projection section 12 to scan a pulse series composed of a plurality of adjustment light pulses having the foregoing mutual relationship in the horizontal scanning direction on screen 10 and decides the pulse width of each of the display light pulses based on the detection result of light detection section 13.

More specifically, while control section 14 gradually increases the pulse width of each of the adjustment light pulses of the pulse series, control section 14 scans the adjustment light pulses in the horizontal scanning direction on screen 10 and decides the pulse width of each of the display light pulses based on the detection result of light detection section 13. Now, it is assumed that each of the adjustment light pulses of the pulse series that laser projection section 12 scans has the same pulse width.

Now, it is assumed that light detection section 13 detects feedback light that is radiated from individual color stripes 21. At this point, if the detection period of sub feedback light that is radiated when laser projection section 12 scans laser light this time does not increase compared with that when laser projection section 12 scans laser light the last time, control section 14 decides that the pulse width of each of the adjustment light pulses that laser projection section 12 scans laser light this time is the pulse width of each of the display light pulses.

If the detection period of sub feedback light does not increase, it denotes that an adjustment light pulse corresponding to the sub feedback light protrudes from color stripe 21. Thus, in the foregoing methods, since the pulse width of each of the adjustment light pulses that protrude from color stripe 21 is decided to be the pulse width of each of display light pulses, the amount of light of the light pulses that enter color stripes 21 can be maximized. Thus, while the luminance of the display image is maximized, the use efficiency of laser light can be decreased.

When light detection section 13 detects feedback light radiated from each of color stripes 21, control section 14 obtains the sum of the luminance of sub feedback light radiated from each of color stripes 21. If the increase rate of the sum of luminance of sub feedback light radiated from each of color stripes 21 does not become linear, control section 14 may decide that the pulse width of each of the adjustment light pulses that laser projection section 12 scans this time is the pulse width of each of display light pulses.

In this case, since the pulse width of each of the adjustment light pulses becomes the pulse width of each of display light pulses when the increase rate of luminance becomes low, while the use efficiency of laser light is maximized, the luminance of the display image can be maximized.

Besides the foregoing methods, control section 14 may obtain the maximum moving speed V at the incident position of laser light on screen 10 based on the detection result that corresponds to the mutual relationship between the emission timing and the pulse width obtained when laser projection section 12 scans laser light and then obtains the pulse width of each of the display light pulses based on maximum moving speed V.

In this case, as shown in FIG. 7, it is assumed that the width of each of color stripes 21 is denoted by R, the width of each of black stripes 22 is denoted by Q, and the beam diameter of laser light is denoted by D, and the pulse width is denoted by W, control section 14 decides that W=(R+2D)/V if the relationship of Q>D is satisfied and that W=(R+2Q−D)/V if the relationship of Q <D is satisfied. In addition, it is assumed that the width R of each of color stripes 21, the width Q of each of black stripes 22, and the beam width D of laser light are fixed values and that control section 14 has stored these values. In this case, while the luminance of the display image is maximized, the use efficiency of laser light can be decreased.

Alternatively, control section 14 may decide that each pulse width W is expressed by W=(R−D)/V. In this case, while the use efficiency of laser light is maximized, the luminance of the display image can be maximized.

When control section 14 specifies the mutual relationship between the emission timing and pulse width of each of display light pulses and the pulse width of each of the display light pulses according to one of the foregoing methods, control section 14 generates control information that represents the emission timing and pulse width of each of the display light pulses based on the mutual relationship and the pulse width. For example, control section 14 substitutes the obtained pulse width into the mutual relationship, obtains the emission timing, and thereby generates control information that represents the specifies pulse width and emission timing.

Control section 14 holds the generated control information or records it in external memory (not shown) or the like.

FIG. 8 shows that projector 1 that has the foregoing structure scans laser light on screen 10. In FIG. 8, laser scanning section 30 is provided with laser light source section 11, laser projection section 12, light detection section 13, and control section 14 shown in FIG. 1.

In the example shown in FIG. 8, the drawing start position of an image is at the upper left position of display region 31. Laser light projected from laser scanning section 30 moves in the direction that intersects the longitudinal direction of color stripes 21 on screen 10. The incident position of laser light moves from the left end to the right end of the display region on screen 10 as represented by trajectory 32. When laser light reaches the right end on screen 10, the laser light turns back there and moves to the left end. Likewise, the laser light turns back at the left end and then moves to the right end again. Such a scanning operation is continuously performed from the upper side to the lower side on screen 10.

In projector 1 according to this embodiment, the longitudinal direction of color stripes 21 corresponds to the vertical direction. Laser scanning section 30 scans laser light in the horizontal direction on screen 10 so as to move the incident position of laser light in the direction that intersects the longitudinal direction of color stripes 21. However, if the longitudinal direction of color stripes 21 corresponds to the horizontal direction, laser scanning section 30 may scan laser light in the vertical direction on screen 10 so as to move the incident position of laser light in the direction that intersects the longitudinal direction of color stripes 21.

As described above, according to this embodiment, the light emission timing and light emission period of laser light source section 11 are adjusted based on the detection result of light detection section 13 such that light pulses enter individual color stripes. Thus, even if the scanning speed of projector 1 changes, light pulses can be caused to enter color stripes 21. As a result, the use efficiency of laser light emitted from laser light source section 11 can be increased.

Next, a second embodiment of the present invention will be described.

According to the second embodiment, after control section 14 has completed the calibration, while laser projection section 12 is scanning laser light that corresponds to an input image signal, control section 14 adjusts the emission timing and pulse width of each of the display light pulses.

After control section 14 has completed the calibration, control section 14 causes laser light source section 11 and laser projection section 12 to scan a pulse series composed of display light pulses corresponding to the input image signal on screen 10.

At this point, control section 14 obtains the maximum moving speed V of laser light on screen 10 based on the detection result of light detection section 13 and thereby corrects control information based on the maximum moving speed V. For example, control section 14 obtains the pulse width and emission timing of each of display light pulses based on the maximum moving speed V and corrects the pulse width and emission timing represented by the control information with those that have been obtained.

The timing at which control information is corrected may be every frame, every predetermined number of frames of a display image, or every horizontal scanning period. The method by which the pulse width and emission timing of each of the display light pulses based on the maximum moving speed V are obtained may be the same as that according to the first embodiment.

According to the second embodiment, while laser projection section 12 is scanning laser light that corresponds to an input image signal on the screen, the control information is corrected. Thus, even if the scanning speed that corresponds to the input image signal changes, the luminance of a display image can be optimized.

The structures according to the foregoing embodiments are just examples. Thus, it should be appreciated that the present invention is not limited to such structures.

Projector 1 may be applied to a multiprojector system having projectors 1-1 to 1-9 shown in FIG. 9. In the multiprojector system, projected images of projectors 1-1 to 1-9 are arranged and displayed on a screen so as to display a large image. FIG. 9 shows a multiprojector system having nine projectors. Specifically, the number of projectors may be two or more.

If projector 1 is applied to a multiprojector system, since projector 1 is not necessary to be provided with special marks that generate feedback light and that are arranged outside a display region, a multiprojector system that seamlessly displays individual projection images can be provided.

The present application claims priority based on Japanese Patent Application JP 2010-276835 filed on Dec. 13, 2010, the entire contents of which are incorporated herein by reference in its entirety.

1. A projector comprising:
a screen having color stripes that are periodically arranged and that generate visible light corresponding to incident light;
a light source that emits a light beam;
a projection section that scans said light beam on a region of said color stripes arranged on said screen;
a detection section that detects feedback light radiated from said screen corresponding to said light beam; and
a control section that adjusts a light emission timing and a light emission period of said light source based on a detection result of said detection section and causes said light source to emit said light beam such that light pulses enter the individual color stripes.

2. The projector as set forth in claim 1,
wherein said control section causes said light source to emit continuous light as said light beam, causes said projection section to scan the continuous light in a direction that intersects with the individual color stripes on said screen, generates control information that represents an emission timing and a pulse width of each light pulse based on said detection result of said detection section of said detection section, and adjusts the light emission timing and light emission period of said light source corresponding to the control information.

3. The projector as set forth in claim 2,
wherein said control section specifies the relationship between the emission timing and pulse width of each light pulse and the pulse width of each light pulse based on said detection result and generates said control information corresponding to the specified relationship and the pulse width.

4. The projector as set forth in claim 3,
wherein said detection section detects sub feedback light from each color stripe as said feedback light, and wherein said control section specifies said relationship as expressed by
$${a}_{i} = {t}_{i} + \frac{{d}_{i} - W}{2}$$
assuming that the detection timing of sub feedback light radiated from i-th color stripe in said direction is denoted by tᵢ, the detection width of the sub feedback light is denoted by dᵢ, the emission timing of a light pulse that enters said i-th color stripe is denoted by aᵢ, and the pulse width of each light pulse is denoted by W.

5. The projector as set forth in claim 3,
wherein said detection section detects sub feedback light radiated from a plurality of predetermined detection stripes of said plurality of color stripes as said feedback light, and wherein said control section specifies said relationship as expressed by
$${aj}_{i} = {t}_{i} + \frac{{d}_{i} - W}{2} + ( j - 1 ) \cdot \frac{{t}_{i + 1} - {t}_{i}}{n}$$
assuming that the detection timing of feedback light radiated from i-th detection stripe in said direction is denoted by tᵢ, the detection width of the feedback light is denoted by dᵢ, the number of target color stripes arranged from said i-th detection stripe to a color stripe immediately preceded by the next detection stripe is denoted by n, the emission timing of a light pulse that enters a target color stripe apart from said i-th detection stripe by j stripes is denoted by ajᵢ, and the pulse width of each light pulse is denoted by W.

6. The projector as set forth in claim 5,
wherein said color stripes on said screen comprise a plurality of color stripes that have different wavelengths of said visible light and that are periodically arranged in a predetermined order, and
wherein said detection stripes are sub color stripes that generate visible light having a predetermined wavelength of said sub color stripes.

7. The projector as set forth in claim 3,
wherein said screen has black stripes each of which is arranged between adjacent color stripes and that block incident light,
wherein said detection section detects sub feedback light radiated from each black stripe as said feedback light, and
wherein said control section specifies said relationship as expressed by
$${b}_{i} = \frac{{t}_{i + 1} + {t}_{i} + {d}_{i} - W}{2}$$
assuming that the detection timing of sub feedback light radiated from i-th black stripe in said direction is denoted by tᵢ, the detection width of the sub feedback light is denoted by dᵢ, the emission timing of a light pulse that enters a color stripe that is immediately preceded by said i-th black stripe is denoted by bᵢ, and the pulse width of each light pulse is denoted by W.

8. The projector as set forth in claim 3,
wherein said control section specifies the maximum moving speed V at the incident position of said light beam on said screen based on said detection result and thereby specifies the pulse width W as expressed by W=(R+2D)/V if Q>D and as expressed by W=(R+2Q−D)/V if Q<V
assuming that the width of each color stripe is denoted by R, the width of each black stripe is denoted by Q, and the beam diameter of said light beam is denoted by D.

9. The projector as set forth in claim 3,
wherein said control section specifies the maximum moving speed V at the incident position of said light beam on said screen and thereby specifies the pulse width W of each light pulse as expressed by W=(R−D)/V assuming that the width of each color stripe is denoted by R and the beam diameter of said light beam is denoted by D.

10. The projector as set forth in claim 3,
wherein said control section causes said light source and said projection section to continuously scan a plurality of adjustment light pulses having said relationship in said direction while increasing the pulse width of each adjustment light pulse and specifies the pulse width of each light pulse based on the detection result of said detection section.

11. The projector as set forth in claim 10,
wherein said detection section detects second sub feedback light radiated from each color stripe as said feedback light, and
wherein if the detection period of second sub feedback light radiated when said projection section scans said adjustment light pulse this time does not increase compared with that when said projection section scans said adjustment light pulse last time, said control section specifies the pulse width of each adjustment light pulse that said projection section scans this time as the pulse width of each light pulse.

12. The projector as set forth in claim 10,
wherein said detection section detects second sub feedback light radiated from each color stripe as said feedback light, and
wherein if the increase rate of the sum of the luminance of second sub feedback light is not linear when said projection section scans said adjustment light pulse, said control section specifies the pulse width of each adjustment light pulse when said projection section scans said adjustment light pulse this time as the pulse width of each light pulse.

13. The projector as set forth in claim 2,
wherein while said control section adjusts the light emission timing and light emission period of said light source, said control section causes said projection section to scan said light beam corresponding to an input image signal and corrects said control information based on said detection result of said scanning

14. A control method for a projector including a screen having color stripes that are periodically arranged and that generate visible light corresponding to incident light; a light source that emits a light beam; and a projection section that scans said light beam on a region of said color stripes arranged on said screen, the method comprising:
detecting feedback light radiated from said screen corresponding to said light beam; and
adjusting a light emission timing and a light emission period of said light source based on the detection result and causing said light source to emit said light beam such that light pulses enter the individual color stripes.

15. The projector as set forth in claim 4, wherein said control section specifies the maximum moving speed V at the incident position of said light beam on said screen based on said detection result and thereby specifies the pulse width W as expressed by W=(R+2D)/V if Q>D and as expressed by W=(R+2Q−D)/V if Q<V
assuming that the width of each color stripe is denoted by R, the width of each black stripe is denoted by Q, and the beam diameter of said light beam is denoted by D.

16. The projector as set forth in claim 5, wherein said control section specifies the maximum moving speed V at the incident position of said light beam on said screen based on said detection result and thereby specifies the pulse width W as expressed by W=(R+2D)/V if Q>D and as expressed by W=(R+2Q−D)/V if Q 21 V
assuming that the width of each color stripe is denoted by R, the width of each black stripe is denoted by Q, and the beam diameter of said light beam is denoted by D.

17. The projector as set forth in claim 6, wherein said control section specifies the maximum moving speed V at the incident position of said light beam on said screen based on said detection result and thereby specifies the pulse width W as expressed by W=(R+2D)/V if Q>D and as expressed by W=(R+2Q−D)/V if Q<V
assuming that the width of each color stripe is denoted by R, the width of each black stripe is denoted by Q, and the beam diameter of said light beam is denoted by D.

18. The projector as set forth in claim 7, wherein said control section specifies the maximum moving speed V at the incident position of said light beam on said screen based on said detection result and thereby specifies the pulse width W as expressed by W=(R+2D)/V if Q>D and as expressed by W=(R+2Q−D)/V if Q<V
assuming that the width of each color stripe is denoted by R, the width of each black stripe is denoted by Q, and the beam diameter of said light beam is denoted by D.

19. The projector as set forth in claim 4, wherein said control section specifies the maximum moving speed V at the incident position of said light beam on said screen and thereby specifies the pulse width W of each light pulse as expressed by W=(R−D)/V assuming that the width of each color stripe is denoted by R and the beam diameter of said light beam is denoted by D.

20. The projector as set forth in claim 5, wherein said control section specifies the maximum moving speed V at the incident position of said light beam on said screen and thereby specifies the pulse width W of each light pulse as expressed by W=(R−D)/V assuming that the width of each color stripe is denoted by R and the beam diameter of said light beam is denoted by D.
